(19) United States
(12) Patent Application Publication
(10) Pub. No.: US 2014/0362608 A1
(43) Pub. Date: Dec. 11, 2014

(54) METHOD FOR PROGRAMMABLE PRIMARY-SIDE-REGULATED POWER CONVERTER

(71) Applicant: SYSTEM GENERAL CORP., New Taipei City (TW)

(72) Inventor: Ta-Yung Yang, Milpitas, CA (US)

(21) Appl. No.: 14/295,329

(22) Filed: Jun. 3, 2014

Related U.S. Application Data
(60) Provisional application No. 61/833,685, filed on Jun. 11, 2013.

(51) Int. Cl. H02M 3/335

(52) U.S. Cl. CPC H02M 3/33507
USPC 363/21.01

(57) ABSTRACT

The invention discloses a method for controlling a programmable primary-side-regulated power converter. The method includes the following steps. A light load situation is enabled for a first time period at a secondary side of a transformer. A transmit-code is generated at the secondary side of the transformer. A current pulse signal is generated at the secondary side of the transformer according to the transmit-code after the first time period. The light load situation is detected at a primary side of the transformer for the first time period. A current signal is detected by detecting a primary side switching current of the transformer. A receive-code is generated according to the current signal. An output current and/or an output voltage of the power converter is generated in accordance with the receive-code. The transmit-code and the receive-code are correlated. The current pulse signal and the current signal are correlated.

### CROSS REFERENCE TO RELATED APPLICATION

This application claims the priority benefits of U.S. provisional application Ser. No. 61/833,685, filed on Jun. 11, 2013. The entirety of the above-mentioned patent applications is hereby incorporated by reference herein and made a part of this specification.

### BACKGROUND

1. Field of the Invention

The present invention relates to a method for a primary side regulated programmable power converter and more particularly to a method and solution for the mobile device to control a programmable primary-side-regulated (PSR) power converter.

2. Description of Related Art

Various power converters have been widely used to provide regulated voltage and current. For the sake of safety reasons, an off-line power converter must provide galvanic isolation between its primary side and secondary side. Therefore, an opto-coupler and a secondary-side regulator are necessary to regulate an output voltage and an output current of the power converter since the control circuit is provided at the secondary side of the power converter.

Nowadays, programmable power converters are more and more popular for convenience of consumers. However, output voltage or output current of traditional programmable power converter is regulated from the secondary side of the programmable power converter. The cost of those secondary-side regulation is high and occupation volume for the all power converter is large due to devices needed for the secondary side. The object of the present invention is to provide a low cost, low device-count and good performance programmable primary-side regulated power converter.

### SUMMARY

The present invention provides a method for controlling a programmable primary-side-regulated power converter, comprises the following steps: enabling a light load situation for a first time period at the secondary side of a transformer; generating a transmit code at the secondary side of the transformer; generating a current pulse signal at the secondary side of the transformer according to the transmit code after the first time period. The method of the present invention also comprises: during the first time period, detecting the light load situation at the primary side of the transformer; generating a current signal by detecting the primary-side switching current of the transformer; generating a receive code according to the current signal; generating the output current and/or the output voltage of the power converter according to the receive code. Furthermore, the transmit-code and the receive-code are correlated, and the current pulse signal and the current signal are correlated.

From another point of view, the present invention further provides a method for controlling a programmable primary-side regulated power converter. The method comprises the following steps: enabling a light load situation at the secondary side of a transformer; generating a transmit-code at the secondary side of the transformer; detecting the light load situation at the primary side of the transformer; receiving a receive code, and generating output current and/or output voltage of the power converter in accordance with the receive code. A dummy load is connected to the output voltage of the power converter when the output voltage is higher than a high-voltage threshold. The transmit code and the receive code are correlated.

### BRIEF DESCRIPTION OF THE DRAWINGS

The accompanying drawings are included to provide a detailed illustration of the invention, and are incorporated in and constitute a part of this specification. The drawings illustrate embodiments of the invention and, together with the description, serve to explain the principles of the invention.

FIG. 1 shows a circuit diagram illustrating a power converter according to one embodiment of the present invention.

FIG. 2 shows a flow chart flowchart illustrating a control flow of a control circuit according to one embodiment of the present invention.

FIG. 3 shows a flow chart of a control flow of a control circuit according to one embodiment of the present invention.

FIG. 4 shows a circuit diagram illustrating the PSR switching-control circuit according to an embodiment of the present invention.

FIG. 5 shows a circuit diagram illustrating the PWM circuit according to an embodiment of the present invention.

FIG. 6 shows a circuit diagram illustrating the code receiver circuit according to an embodiment of the present invention.

FIG. 7 shows a control flow of the code-demodulation circuit according to an embodiment of the present invention.

FIG. 8 shows a flow of the code-demodulation circuit according to an embodiment of the present invention.

FIG. 9 shows a flow of the code-demodulation circuit according to an embodiment of the present invention.

FIG. 10 shows a circuit diagram illustrating the dummy load circuit according to an embodiment of the present invention.

### DETAILED DESCRIPTION OF DISCLOSED EMBODIMENTS

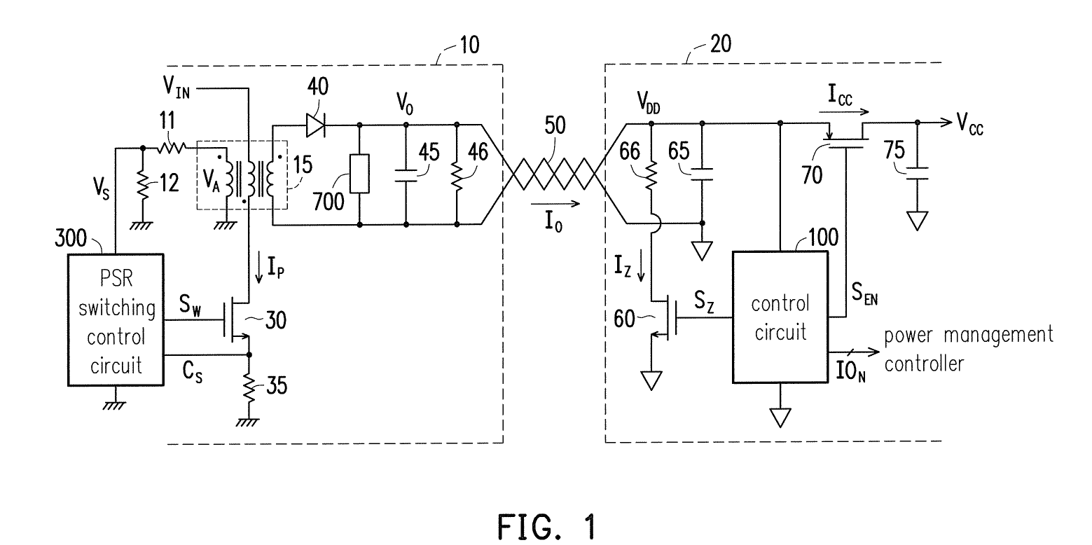

FIG. 1 shows a circuit diagram illustrating a power converter according to one embodiment of the present invention. The power converter 10 is connected to a mobile device 20. The power converter 10 is a programmable primary-side-regulated (PSR) power converter, but the invention is not limited thereto. The power converter 10 includes resistors 11 and 12, a transformer 15, a transistor 30, a resistor 35, a rectifier 40, a capacitor 45, a PSR switching-control circuit 300 and a dummy load circuit 700. The PSR switching-control circuit 300 generates a switching signal S_{W} for switching the transformer 15 via the transistor 30. The transformer 15 generates the output voltage V_{O} and the output current I_{O} via the rectifier 40 and the capacitor 45. The dummy load resistor 46 is connected to the output of the power converter 10. The resistor 35 connected in series with the transistor 30 is used for detecting the transformer current I_{P} and generating a current signal Cs coupled to the PSR switching-control circuit 300.

The PSR switching-control circuit 300 is further coupled to the transformer 15 through the resistors 11 and 12 to detect a reflected voltage V_{S} and a demagnetizing time (the discharge time signal T_{DS}) of the transformer 15.

The output of the power converter 10 is connected to the mobile device 20 through a cable 50. Therefore, the output voltage V_{O} of the power converter 10 will produce a voltage V_{DD} at the mobile device 20. The voltage V_{DD} is equivalent to the voltage V_{O} subtracting the voltage drop at the cable 50. A control circuit 100 of the mobile device 20 includes a communication interface IO_{N} coupled to the power management controller of the mobile device 20. The control circuit 100 generates a signal S_{EN} configured to control the on/off of a transistor 70. When the control circuit 100 enables the signal S_{EN} to turn on the transistor 70, the voltage V_{DD} will be able to supply the power (V_{CC} voltage) to the circuit of the mobile device 20. The V_{CC} voltage is also applied to charge a battery of the mobile device 20. The power converter 10 will operate in the light load when the control circuit 100 disables the signal S_{EN} (i.e., the transistor 70 is turned off). The control circuit 100 further generates a signal S_{Z} to enable a current I_{Z} through a transistor 60 and a resistor 66. The control circuit 100 applies the signal S_{Z} to turn on the transistor 60, such that a CODE (i.e., the current I_{Z}) from the mobile device 20 to the power converter 10. The CODE is used for determining the value of the output voltage V_{O} and the output current I_{O} of the power converter 10. The CODE can only be transmitted during the light load according to the present invention. Therefore, the CODE that is produced by the current I_{Z} can be well detected and received by the PSR switching-control circuit 300.

Furthermore, the dummy load circuit 700 is coupled to the output voltage V_{O} to provide a discharge path for the output capacitor 45 when the output voltage V_{O} is higher than a high-voltage threshold. The dummy load circuit 700 will help discharge the capacitor 45 faster when the output voltage V_{O} is set to the default value and/or the cable 50 is removed.

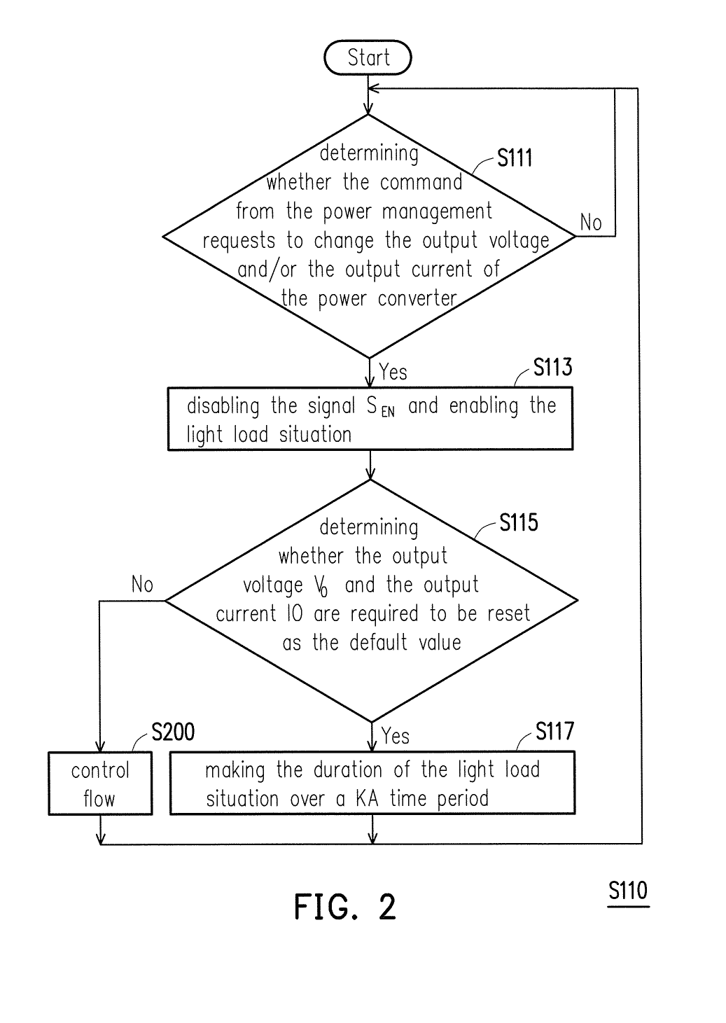

FIG. 2 shows a flow chart flowchart illustrating a control flow for a control circuit according to one embodiment of the present invention. In the present embodiment, a control flow S110 may be implemented by the control circuit 100. When the control circuit 100 receives the command from the power management controller (via the communication interface IO_{N}), the control circuit 100 will start the control flow S110. In step S111, the control circuit 100 determines whether the command from the power management requests to change the output voltage V_{O} and/or the output current I_{O} of the power converter 10. If the command requests to change the output voltage V_{O} and/or the output current I_{O}, then the control circuit 100 will proceed the step S113 to disable the signal S_{EN} and enable the light load situation. Next, in step S115, the control unit 100 determines whether the output voltage V_{O} and the output current I_{O} are required to be reset as the default value. If the output voltage V_{O} and the output current I_{O} are required to be reset as the default value, the control circuit 100 will proceed to the step S117 to make the duration of the light load situation over a KA time period (time delay), where KA is a constant. When the PSR switching-control circuit 300 detects that the duration of the light load situation is more than the KA time period, the PSR switching-control circuit 300 will output the default value of the output voltage V_{O} and the output current I_{O} (such as 5V/2A). If the output voltage V_{O} and the output current I_{O} are not required to be reset as the default value, the control circuit 100 will proceed a control flow S200 to send the CODE to the PSR switching-control circuit 300.

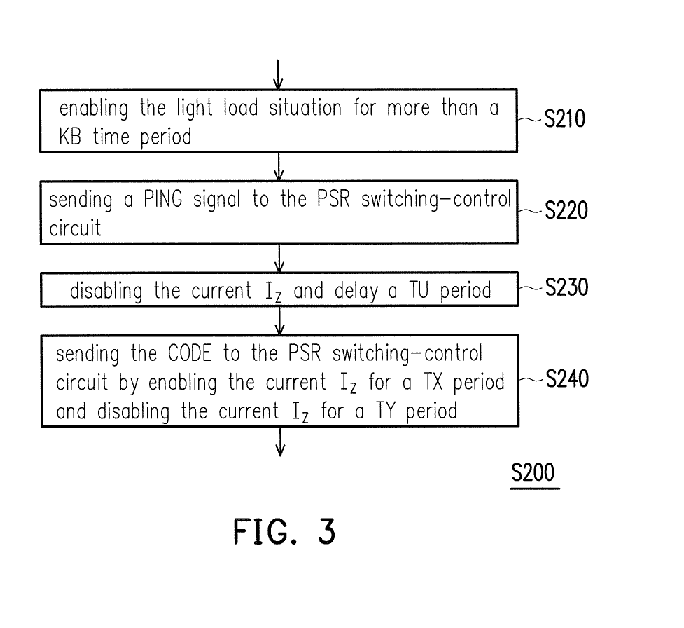

FIG. 3 shows a flow chart of a control flow for a control circuit according to one embodiment of the present invention. In the present embodiment, the control flow S200 may be implemented by the control circuit 100.

In step S210, the control circuit 100 enables the light load situation for more than a KB time period (time delay), where KB is a constant and KA>KB. When the PSR switching-control circuit 300 detects the duration of the light load situation is over the KB time period (and less than the KA time period), the PSR switching-control circuit 300 will enable to receive the CODE. After the step S210, the control circuit 100 will perform the step S220 to send a PING signal to the PSR switching-control circuit 300. The PING signal may be characterized by the enabling the current I_{Z} (i.e., enabling the signal S_{Z}) for a T_{W} period. After step S220, in step S230, the control circuit 100 disables the current I_{Z} and delay a TU period. Afterwards, in the step S250, the control circuit 100 sends the CODE to the PSR switching-control circuit 300 by enabling the current I_{Z} (i.e., enabling the signal S_{Z}) for a TX period and disabling the current I_{Z} (i.e., disabling the signal S_{Z}) for a TY period. The CODE can be a digital data signal and/or a frequency signal.

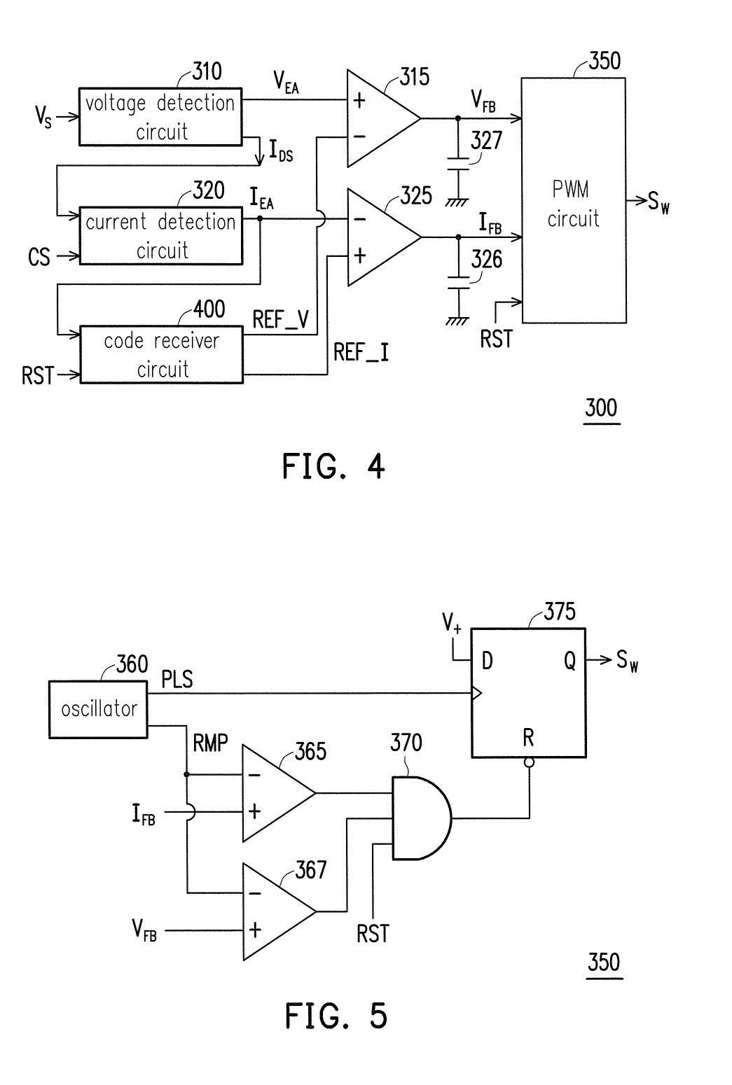

FIG. 4 shows a circuit diagram illustrating the PSR switching-control circuit according to an embodiment of the present invention. Referring to FIG. 1 and FIG. 4, the reflected voltage V_{S} of the transformer 15 is configured to generate a signal V_{EA} that is related to the output voltage V_{O}. The demagnetizing time (signal T_{DS}) associated with the current signal Cs generate a signal I_{EA} that is related to the output current I_{O}. The signal V_{EA} is used for developing a voltage feedback loop for regulating the output voltage V_{O}. The signal I_{EA} is used for developing a current feedback loop for regulating the output current I_{O}.

The PSR switching-control circuit 300 includes a voltage detection circuit 310, amplifiers 315 and 325, a current detection circuit 320, capacitors 326 and 327, pulse width modulation (PWM) circuit 350 and a code receiver circuit 400. The voltage detection circuit 310 generates a voltage-loop signal V_{EA} and a discharge time signal TDS in response to the reflected signal V_{S}. The voltage-loop signal V_{EA} is correlated to the output voltage V_{O}. The discharge time signal T_{DS} is correlated to the demagnetizing time of the transformer 15. The current detection circuit 320 generates the current-loop signal I_{EA} in response to the current signal C_{S} and the discharge time signal TDS. The current-loop signal I_{EA} is correlated to the output current I_{O}. The voltage detection circuit 310 and the current detection circuit 320 are related to the technology of the primary side regulation (PSR) of the power converter.

The voltage-loop signal V_{EA} is coupled to the amplifier 315 for generating a voltage feedback signal V_{FB} according to a reference signal REF_V. The capacitor 327 is coupled to the voltage feedback signal V_{FB} for the loop compensation. The current-loop signal I_{EA} is coupled to the amplifier 325. The current-loop signal I_{EA} associated with a reference signal REF_I generates a current feedback signal I_{FB}. The capacitor 326 is coupled to the current feedback signal I_{FB} for the loop compensation.

The code receiver circuit 400 is coupled to generate the reference signals REF_V and REF_I in response to the CODE and a power-on reset signal RST. The CODE is generated in accordance with the decoding of the current-loop signal I_{EA}. The reference signal REF_V is operated as a voltage reference signal for regulating the output current V_{O} of the power converter 10. The reference signal REF_I is operated as a current reference signal for regulating the output current I_{O} of the power converter 10.

The PWM circuit 350 generates the switching signal S_{W} in response to the voltage feedback signal V_{FB}, the current feedback signal I_{FB} and the power-on reset signal RST.

FIG. 5 shows a circuit diagram illustrating the PWM circuit according to an embodiment of the present invention. The PWM circuit 350 includes an oscillator 360, comparators 365 and 367, an AND gate 370 and a flip-flop 375. The oscillator 360 generates a clock signal PLS and a ramp signal RMP. The clock signal PLS periodically turns on the switching signal S_{W} via the flip-flop 375. The switching signal S_{W} will be turned off once the ramp signal RMP is higher than the current feedback signal IFB or the voltage feedback signal V_{FB} in the comparators 365 and 367.

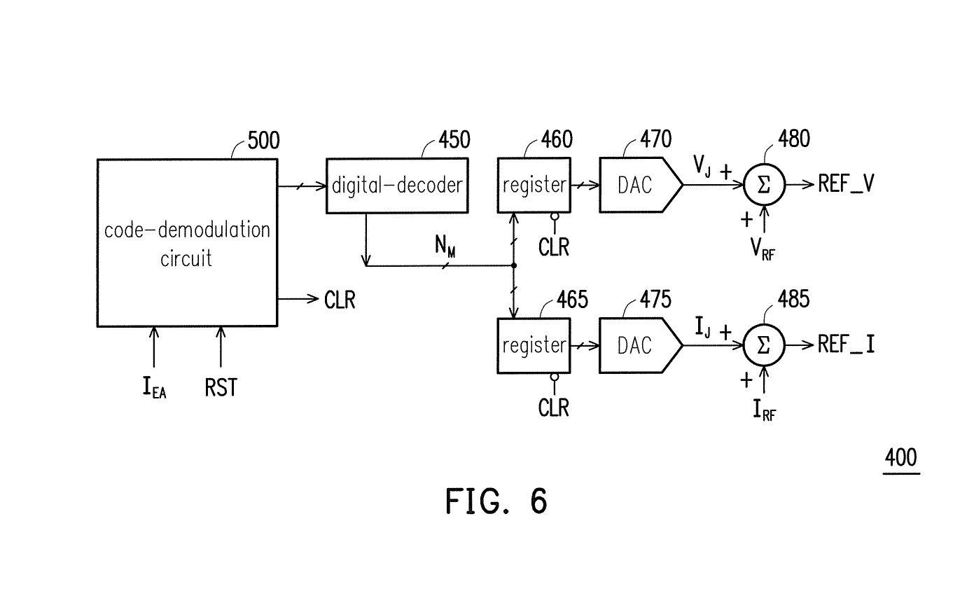

FIG. 6 shows a circuit diagram illustrating the code receiver circuit according to an embodiment of the present invention. The code receiver circuit 400 includes a digital decoder 450, registers 460 and 465, a digital-to-analog (DAC) converters 470 and 475, add circuits 480 and 48, and code-demodulation circuit 500. The code-demodulation circuit 500 generates a demodulation signal and a clear signal CLR in response to the current-loop signal I_{EA} and the power-on reset signal RST. The demodulation signal is coupled to the digital-decoder 450 to generate a digital data N_{M}. The digital data N_{M} is stored into the registers 460 and 465. The register 460 is coupled to the digital-to-analog converter 470 for generating a voltage-adjust signal The add circuit 480 generates the reference signal REF_V by adding a reference signal V_{RF} and the voltage-adjust signal V_{J}.

The register 465 is coupled to the digital-to-analog converter 475 for generating a current-adjust signal I_{J}. The add circuit 485 generates the reference signal REF_I by adding a reference signal I_{RF} and the current-adjust signal b. Therefore, the reference signal REF_V and the reference signal REF_I are programmable by the CODE that is sent from the mobile device 20 (i.e., the signal S_{Z} of the control circuit 100).

The power-on reset signal RST is also coupled to generate the clear signal CLR. The code-demodulation circuit 500 will generate the clear signal CLR when the default value of the output voltage V_{O} and the output current I_{O} is requested. The clear signal CLR is coupled to reset the registers 460 and 465 for resetting the value of the voltage-adjust signal V_{J} and the current-adjust signal I_{J} to the zero. Therefore, the reference signal REF_V will be set to the default value (e.g., the reference signal V_{RF}) in response to the clear signal CLR. Besides, the reference signal REF_I will be set the default value (e.g., the reference signal I_{RF}) for regulating the output current I_{O} once the clear signal CLR is generated.

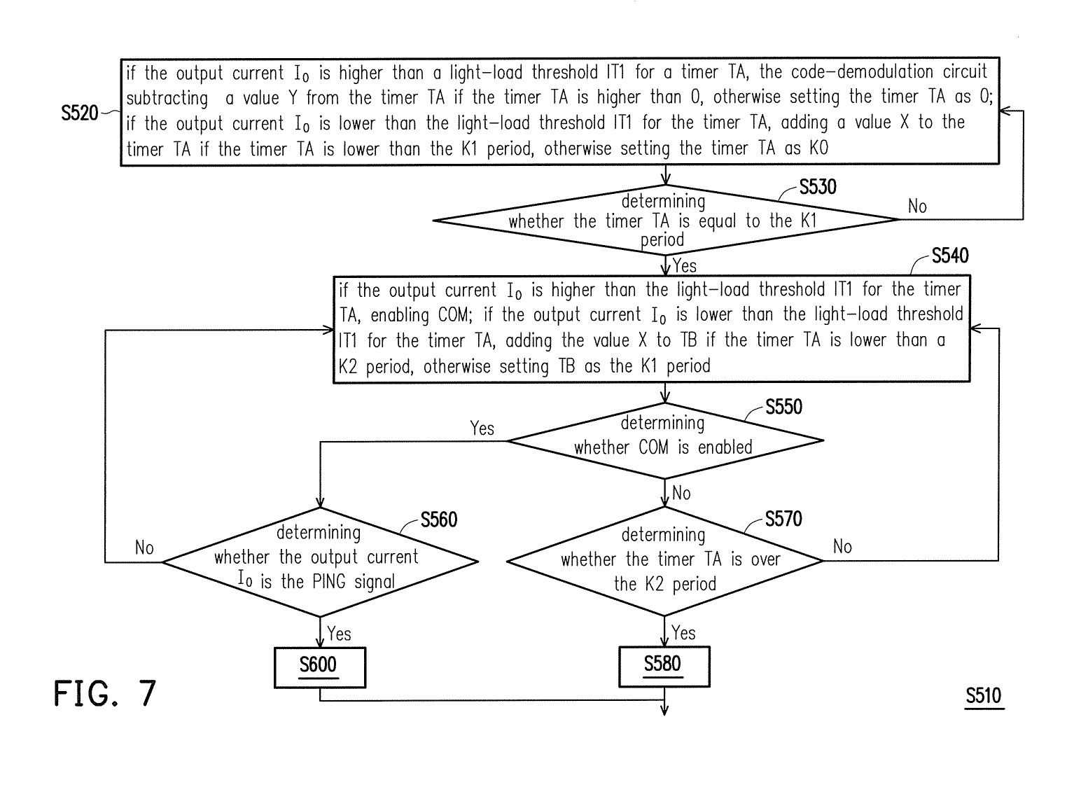

FIG. 7 shows a control flow of the code-demodulation circuit according to an embodiment of the present invention. A control flow S510 could be implemented by the code-demodulation circuit 500. The current-loop signal I_{EA} represents the output current I_{O}. In step S520, the current-loop signal I_{EA} will be compared with a light-load threshold IT1 for starting a timer TA. The light load situation is detected when the value of the current-loop signal I_{EA} is lower than the light-load threshold IT1. Specifically, if the output current I_{O} (i.e., the current-loop signal I_{EA}) is higher than a light-load threshold IT1 for a timer TA, the code-demodulation circuit 500 subtracts a value Y from the timer TA if the timer TA is higher than 0, otherwise sets the timer TA as 0. On the other hand, if the output current I_{O} is lower than the light-load threshold IT1 for the timer TA, the code-demodulation circuit 500 adds a value X to the timer TA if the timer TA is lower than the K1 period, otherwise sets the timer TA as K0.

In step S530, the code-demodulation circuit 500 determines whether the timer TA is equal to the K1 period. If yes, the control flow 5510 proceeds to step S540, otherwise, the control flow 5510 returns to step S520.

In step S540, if the output current I_{O} is higher than the light-load threshold IT1 for the timer TA, the code-demodulation circuit 500 enables COM. On the other hand, if the output current I_{O} is lower than the light-load threshold IT1 for the timer TA, the code-demodulation circuit 500 adds the value X to TB if the timer TA is lower than a K2 period, otherwise sets TB as the K1 period.

In step S550, the code-demodulation circuit 500 determines whether COM is enabled. If COM is enabled, the control flow S510 proceeds to step S560, otherwise, the control flow S510 proceeds to step S570.

In step S560, the code-demodulation circuit 500 determines whether the output current I_{O} (i.e., the current-loop signal I_{EA}) is a PING signal. If I_{O} is a PING signal, the control flow S510 proceeds to a flow S600, otherwise, the control flow 5510 returns to step S540.

In step S570, the code-demodulation circuit 500 determines whether the timer TA is timing for over the K2 period. If yes, the control flow 5510 proceeds to a flow 5580, otherwise, the control flow 5510 returns to step S540.

Generally speaking, if the value of the current-loop signal I_{EA} is lower than the light-load threshold IT1 for over the K2 time period, then the clear signal CLR will be generated in the flow S580 to reset the output voltage V_{O} and the output current I_{O} to the default value.

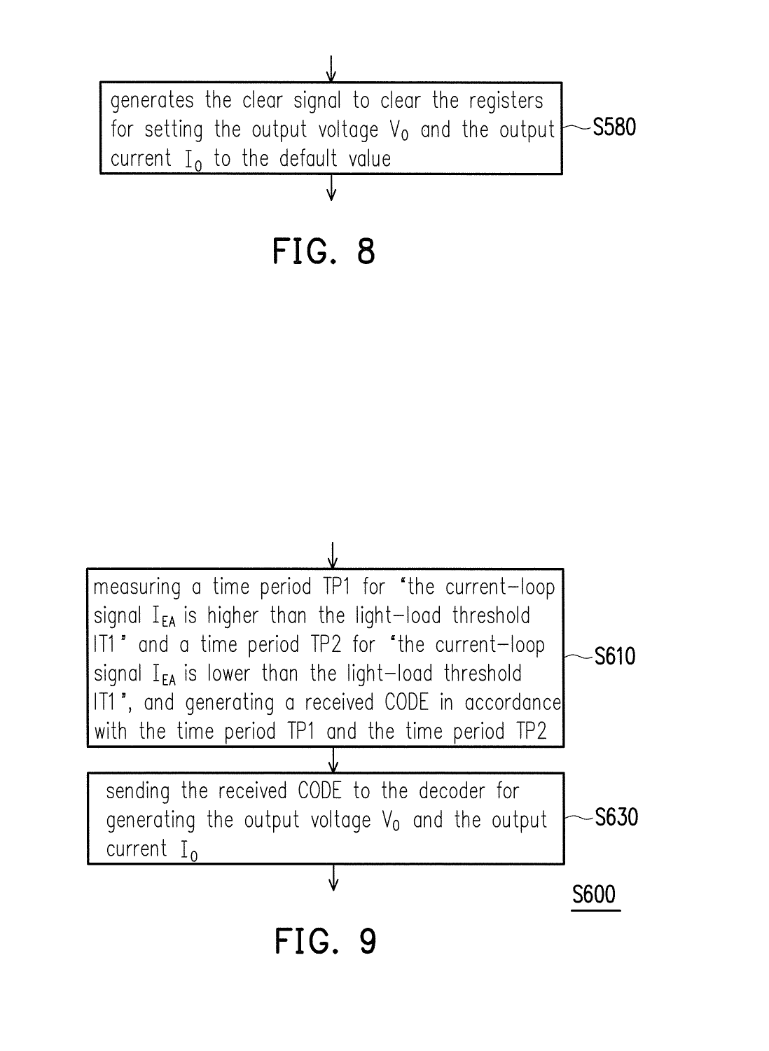

FIG. 8 shows a flow of the code-demodulation circuit according to an embodiment of the present invention. In the flow S580, the code-demodulation circuit generates the clear signal CLR to clear the registers 460 and 465 for setting the output voltage V_{O} and the output current I_{O} to the default value.

FIG. 9 shows a flow of the code-demodulation circuit according to an embodiment of the present invention. The flow S600 could be implemented by the code-demodulation circuit 500. In step S610, the code-demodulation circuit measures a time period TP1 for “the current-loop signal I_{EA} is higher than the light-load threshold IT1” and a time period TP2 for “the current-loop signal I_{EA} is lower than the light-load threshold IT1”, and generates a received CODE in accordance with the time period TP1 and the time period TP2. In step S630, the code-demodulation circuit 500 sends the received CODE to the decoder 450 for generating the output voltage V_{O} and the output current I_{O}.

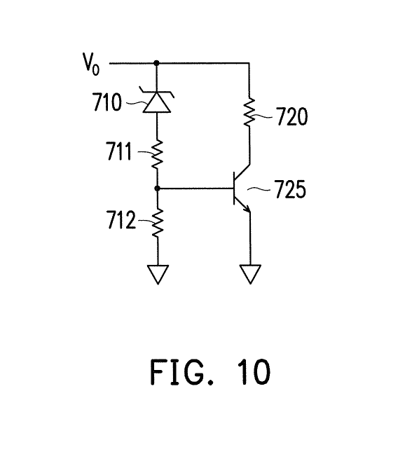

FIG. 10 shows a circuit diagram illustrating the dummy load circuit according to an embodiment of the present invention. In the present embodiment, the dummy load circuit 700 includes a voltage reference device 710, resistors 711, 712 and 725, and a transistor 725. The voltage reference device 710, such as a ZENER diode, is coupled to turn on the transistor 725 via the resistors 711 and 712. The resistor 720 is connected with the transistor 725 in series. The resistor 720 will be coupled to the output voltage V_{O} once the output voltage V_{O} is higher than the high-voltage threshold. The high-voltage threshold is determined by the value the voltage reference device 710 (such as 5.6V).

A specific communication protocol is proposed for the output voltage and output current setting. This programmable power converter provides a wide range of the output voltage and the output current, such as 5V-20V and 0.5A-5A.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for controlling a programmable primary-side-regulated power converter, comprising:
enabling a light load situation for a first time period at a secondary side of a transformer;
generating a transmit-code at the secondary side of the transformer;
generating a current pulse signal at the secondary side of the transformer according to the transmit-code after the first time period;
detecting the light load situation at a primary side of the transformer for the first time period;
detecting a current signal by detecting a primary side switching current of the transformer;
generating a receive-code according to the current signal;
generating an output current and an output voltage of the power converter in accordance with the receive-code; and
wherein the transmit-code and the receive-code are correlated; the current pulse signal and the current signal are correlated.

2. The method as claimed in claim 1, in which the current signal is detected in accordance with the primary side switching current and a demagnetizing time of the transformer.

3. The method as claimed in claim 1, further comprising:
enabling the light load situation for a second time period at the secondary side of the transformer; and
detecting the light load situation and generating a default setting signal at the primary side of the transformer after the second time period; generating the default value of the output current and/or the output voltage once the default setting signal is generated,
wherein the second time period is longer than the first time period.

4. The method as claimed in claim 1, in which the output voltage is regulated in accordance with a reflected voltage of the transformer.

5. The method as claimed in claim 1, in which the output current is regulated in accordance with a current-loop signal, wherein the current-loop signal is generated in response to the primary side switching current of the transformer and a demagnetizing time of the transformer; the value of the current-loop signal is related to the value of the output current of the transformer.

6. The method as claimed in claim 1, in which the light load situation is achieved by turning off a transistor; wherein the transistor is connected to charge a battery.

7. The method as claimed in claim 1, in which the transmit-code is a frequency signal and/or a digital data signal.

8. The method as claimed in claim 1, in which a PING signal is sent before sending the transmit-code.

9. The method as claimed in claim 1, in which the light load situation is enabled by a mobile device.

10. The method as claimed in claim 1, in which the transmit-code is generated in the mobile device.

11. The method as claimed in claim 1, further comprising:
connecting a dummy load to the output voltage of the power converter when the output voltage is higher than a high-voltage threshold.

12. A method for controlling a programmable primary-side-regulated power converter, comprising:
enabling a light load situation at a secondary side of a transformer;
generating a transmit-code at the secondary side of the transformer;
detecting the light load situation at a primary side of the transformer;
receiving a receive-code and generating a output current and a output voltage of the power converter in accordance with the receive-code; and
connecting a dummy load to the output voltage of the power converter when the output voltage is higher than a high-voltage threshold,
wherein the transmit-code and the receive-code are correlated.

13. The method as claimed in claim 12, in which the output voltage is regulated in accordance with a reflected voltage of the transformer.

14. The method as claimed in claim 12, in which the output current is regulated in accordance with a current-loop signal, wherein the current-loop signal is generated in response to the primary side switching current of the transformer and a demagnetizing time of the transformer; the value of the current-loop signal is related to the value of the output current of the transformer.

15. The method as claimed in claim 1, in which the transmit-code is a frequency signal and/or a digital data signal.
